(19) United States
(12) Patent Application Publication
(10) Pub. No.: US 2012/0250640 A1
(43) Pub. Date: Oct. 4, 2012

(54) COMMUNICATION DEVICE, AND COMMUNICATION SYSTEM

(75) Inventors: Masataka Wakamatsu, Kanagawa (JP); Toshio Honda, Kanagawa (JP)

(73) Assignee: SONY CORPORATION, Tokyo (JP)

(21) Appl. No.: 13/423,721

(22) Filed: Mar. 19, 2012

(30) Foreign Application Priority Data
Mar. 30, 2011 (JP) 2011-075767

(51) Int. Cl. H04W 72/00

(52) U.S. Cl. 370/329

(57) ABSTRACT

Provided is a communication device including a streaming packet transmission unit for transmitting a streaming packet, a control information acquisition unit for acquiring control information regarding the streaming packet, a control packet transmission unit for transmitting a control packet including the control information, a control information addition unit for adding the control information to the streaming packet, and a transmission channel selection unit for selecting, according to a predetermined condition, whether to transmit the control packet including the control information or to transmit the streaming packet to which the control information has been added.

### BACKGROUND

The present disclosure relates to a communication device and a communication system.

In recent years, technologies of transmitting video data, audio data and the like using wireless communication are known. For example, JP 2005-176352A describes a technology intended to encode and decode both video data and audio data using a video streaming file. Furthermore, JP 2008-514046T describes a technology intended to provide a wireless audio transmission channel by retrofitting an existing speaker.

### SUMMARY

It is assumed, with respect to transmission of audio data, that control information for specifying the volume of audio, control information for specifying muting of audio, or the like is transmitted while transmission of streaming data or while transmission thereof is stopped. At this time, when these pieces of control information are transmitted using a separate control packet from the streaming data, if during streaming, a transmission right has to be handed over to another device after the transmission of the control packet. Thus, a delay occurs in the transmission of the streaming data.

It is also assumable to transmit these pieces of control information by adding them to the streaming data, but this method allows to specify the volume or muting only while streaming. Thus, it is not possible to change the volume or mute when audio is not being played back, resulting in user inconvenience.

Accordingly, a mechanism of transmitting control information, such as volume, without delay both while streaming and while streaming is stopped is desired.

According to the present disclosure, there is provided a communication device which includes a streaming packet transmission unit for transmitting a streaming packet, a control information acquisition unit for acquiring control information regarding the streaming packet, a control packet transmission unit for transmitting a control packet including the control information, a control information addition unit for adding the control information to the streaming packet, and a transmission channel selection unit for selecting, according to a predetermined condition, whether to transmit the control packet including the control information or to transmit the streaming packet to which the control information has been added.

According to the configuration described above, whether to transmit a control packet including control information or to transmit a streaming packet to which the control information has been added is selected according to a predetermined condition, and thus the control information can be transmitted without causing delay, both while streaming and while streaming is stopped.

Furthermore, according to the present disclosure, there is provided a communication device which includes a streaming packet reception unit for receiving a streaming packet and control information, regarding the streaming packet, added to the streaming packet, a control packet reception unit for receiving a control packet including the control information regarding the streaming packet, a control information acquisition unit for acquiring the control information from the streaming packet or the control packet, and a control unit for controlling information of the streaming packet based on the control information.

According to the configuration described above, control information is acquired from a streaming packet or a control packet and information of the streaming packet is controlled based on the control information, and thus information of the streaming packet can be controlled without causing delay, both while streaming and while streaming is stopped.

Furthermore, according to the present disclosure, there is provided a communication device which includes a streaming packet reception unit for receiving a streaming packet, a reception acknowledgement information transmission unit for transmitting a reception acknowledgement information (ACK) when the streaming packet is received, a control information acquisition unit for acquiring control information regarding the streaming packet, a control packet transmission unit for transmitting a control packet including the control information, a control information addition unit for adding the control information to the reception acknowledgement information (ACK), and a transmission channel selection unit for selecting, according to a predetermined condition, whether to transmit the control packet including the control information or to transmit the reception acknowledgement information (ACK) to which the control information has been added.

According to the configuration described above, whether to transmit a control packet including control information or to transmit a reception acknowledgement information (ACK) to which the control information has been added is selected according to a predetermined condition, and thus the control information can be transmitted without causing delay, both while streaming and while streaming is stopped.

Furthermore, according to the present disclosure, there is provided a communication device which includes a streaming packet transmission unit for transmitting a streaming packet, a control packet reception unit for receiving a control packet including control information regarding the streaming packet, a reception acknowledgement information (ACK) reception unit for receiving reception acknowledgement information (ACK) for the streaming packet and the control information, regarding the streaming packet, added to the reception acknowledgement information (ACK), a control information acquisition unit for acquiring the control information from the reception acknowledgement information (ACK) or the control packet, and a control unit for controlling information of the streaming packet based on the control information.

According to the configuration described above, control information is acquired from the reception acknowledgement information (ACK) or the control packet and information of the streaming packet is controlled based on the control information, and thus information of the streaming packet can be controlled without causing delay, both while streaming and while streaming is stopped.

Furthermore, according to the present disclosure, there is provided a communication system which includes a first communication device including a streaming packet transmission unit for transmitting a streaming packet, a control information acquisition unit for acquiring control information regarding the streaming packet, a control packet transmission unit for transmitting a control packet including the control information, a control information addition unit for adding the streaming packet to the control information, and a transmission channel selection unit for selecting, according to a predetermined condition, whether to transmit the control packet including the control information or to transmit the streaming packet to which the control information has been added, and a second communication device including a streaming packet reception unit for receiving the streaming packet, a control packet reception unit for receiving the control packet, a control information acquisition unit for acquiring the control information from the streaming packet or the control packet, and a control unit for controlling information of the streaming packet based on the control information.

According to the configuration described above, whether to transmit a control packet including control information or to transmit a streaming packet to which the control information has been added is selected according to a predetermined condition, and thus the control information can be transmitted without causing delay, both while streaming and while streaming is stopped.

Furthermore, according to the present disclosure, there is provided a communication system which includes a first communication device including a streaming packet reception unit for receiving a streaming packet, a reception acknowledgement information transmission unit for transmitting reception acknowledgement information (ACK) when the streaming packet is received, a control information acquisition unit for acquiring control information regarding the streaming packet, a control packet transmission unit for transmitting a control packet including the control information, a control information addition unit for adding the control information to the reception acknowledgement information (ACK), and a transmission channel selection unit for selecting, according to a predetermined condition, whether to transmit the control packet including the control information or to transmit the reception acknowledgement information (ACK) to which the control information has been added, and a second communication device including a streaming packet transmission unit for transmitting the streaming packet, a control packet reception unit for receiving the control packet, a reception acknowledgement information (ACK) reception unit for receiving the reception acknowledgement information (ACK) for the streaming packet and the control information, regarding the streaming packet, added to the reception acknowledgement information (ACK), a control information acquisition unit for acquiring the control information from the reception acknowledgement information (ACK) or the control packet, and a control unit for controlling information of the streaming packet based on the control information.

According to the configuration described above, whether to transmit a control packet including control information or to transmit a reception acknowledgement information (ACK) to which the control information has been added is selected according to a predetermined condition, and thus the control information can be transmitted without causing delay, both while streaming and while streaming is stopped.

According to the present disclosure, control information, such as volume, can be transmitted without causing delay both while streaming and while streaming is stopped.

### BRIEF DESCRIPTION OF THE DRAWINGS

FIG. 1 is a schematic diagram showing a schematic configuration of a system according to a first embodiment of the present disclosure;

FIG. 2 is a flow chart showing a process of switching a transmission channel of volume control information;

FIG. 3 is a schematic diagram showing a case where packets are transmitted/received between a master unit and a slave unit;

FIG. 4 is a timing chart showing, as a comparative example against the embodiment, a case of transmitting volume control information only by a control packet;

FIG. 5 is a schematic diagram showing configurations of a master unit and a slave unit of a system of the comparative example of FIG. 4;

FIG. 6 is a schematic diagram showing, as a comparative example, a configuration where volume control information is transmitted to a slave unit being added at all times to a streaming packet;

FIG. 7 is a schematic diagram showing a configuration of a system according to a second embodiment;

FIG. 8 is a schematic diagram showing a case, of the second embodiment, where packets are transmitted/received between a master unit and a slave unit;

FIG. 9 is a schematic diagram showing a configuration of a system according to a third embodiment;

FIG. 10 is a schematic diagram showing a configuration of the system according to the third embodiment;

FIG. 11 is a schematic diagram showing a configuration of a system according to a fourth embodiment; and

FIG. 12 is a schematic diagram showing a case where packets are transmitted/received between a master unit and a slave unit.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

Additionally, an explanation will be given in the following order.

1. First Embodiment
1.1. Base Technology
1.2. Configuration of First Embodiment

2. Second Embodiment
2.1. Overview of Second Embodiment
2.2. Configuration of Second Embodiment

3. Third Embodiment
3.1. Overview of Third Embodiment
3.2. Configuration of Third Embodiment

4. Fourth Embodiment
4.1. Overview of Fourth Embodiment
4.2. Configuration of Fourth Embodiment

### 1. FIRST EMBODIMENT

### 1.1. Base Technology

As a method of controlling volume or muting in audio transmission using wireless communication, a method of transmitting a control packet separate from streaming and a method of placing control information in a part of streaming data, such as a header area, are conceivable. The former method has an issue that, when performing access by CSMA scheme used in wireless LAN and the like, a back-off is necessary after transmission, even with a control packet with a small amount of data, and a waiting time until the next streaming data transmission is increased. In the case of synchronously playing back video and audio, as with a home theater system, audio streaming data has to be transmitted within a delay normally of 30 msec or less, and large buffering is not enabled. Therefore, when there is a waiting time after the control packet transmission until the next streaming data transmission, this may result in interruption of sound. If transmission of control data is made less frequent, the probability of such an issue arising may be lowered to a certain degree, but if, for some reason, a slave unit (the receiving end of control information) fails to receive a control packet, the time until the control by the master unit is reflected by the slave unit increases. Thus, it is difficult to reduce the transmission frequency by greatly thinning out control packets.

On the other hand, with the latter method, control data is added to streaming data as a header and they are transmitted as one packet, and thus the issue of the former method that a delay occurs in the transmission of streaming data because of a transmission waiting time caused due to a back-off arises less frequently. However, with this method, control data is not transmitted unless streaming transmission is performed. Accordingly, for example, if a user performs volume operation while a media player is stopped, information on the volume operation is not transmitted to a slave unit. That is, freedom of control is restricted.

Accordingly, the present disclosure switches between whether to add control information, such as volume, as a part of a streaming data packet and transmit the same or to transmit it as an individual control data packet, depending on the state of streaming. This enables to minimize the transmission waiting time for streaming data even in a state where a wireless band is crowded, while maintaining the freedom of control.

### 1.2. Configuration of First Embodiment

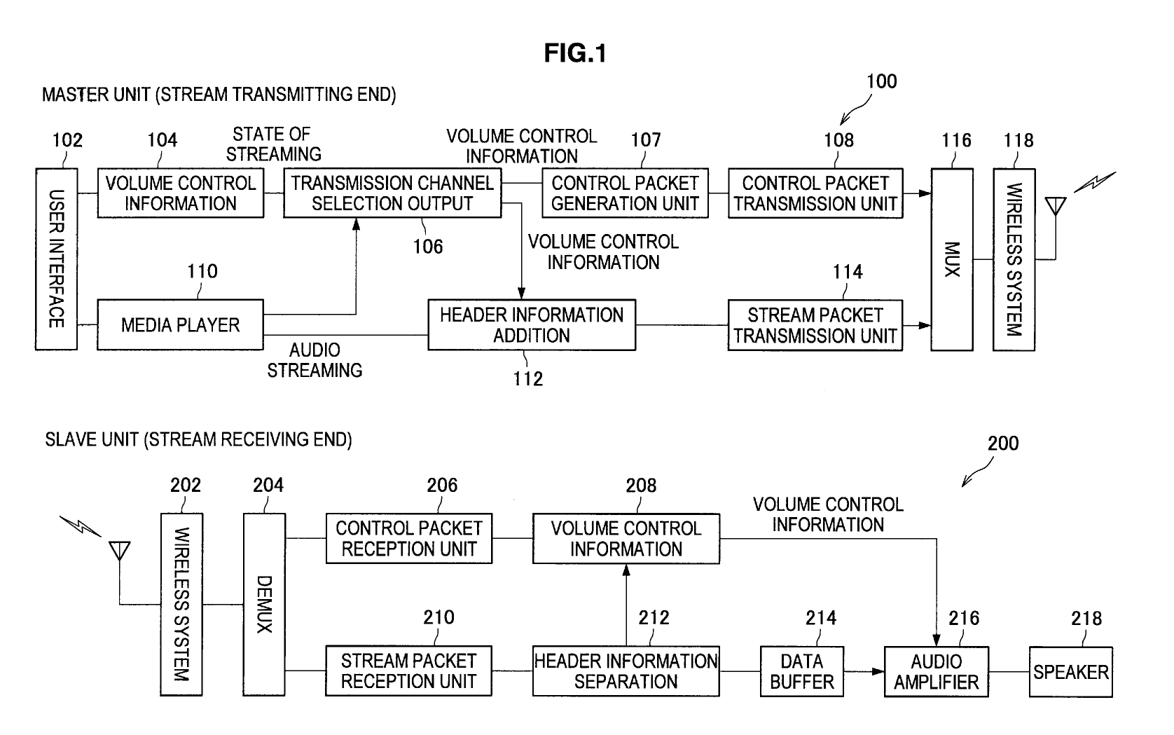

First, a schematic configuration of a system according to a first embodiment of the present disclosure will be described with reference to FIG. 1. In FIG. 1, streaming of audio data from a master unit to a slave unit is assumed, and a system in which control of volume or muting at the slave unit is performed by the master unit is illustrated.

As shown in FIG. 1, the system according to the present embodiment is configured by having a master unit 100 and a slave unit 200 as communication devices. The master unit 100 includes a user interface 102, a volume control information acquisition unit 104, a transmission channel selection output unit 106, a control packet generation unit 107, a control packet transmission unit 108, a media player 110, a header information addition unit 112, a stream packet transmission unit 114, a MUX 116 and a wireless system 118.

Also, the slave unit 200 includes a wireless system 202, a DEMUX 204, a control packet reception unit 206, a volume control information acquisition unit 208, a stream packet reception unit 210, a header information separation unit 212, a data buffer 214, an audio amplifier 216 and a speaker 218.

First, processing performed by the master unit 100 will be described. Volume operation by a user is input to the user interface 102, and is acquired by the volume control information acquisition unit 104 as volume control information. The media player 110 transmits information regarding the state of streaming (information indicating whether streaming is performed or not) to the transmission channel selection output unit 106. In the case streaming is not performed at the media player 110, the transmission channel selection output unit 106 transmits the volume control information to the control packet generation unit 107. The control packet generation unit 107 generates a control packet including the volume control information, and transmits the same to the control packet transmission unit 108. The control packet transmission unit 108 transmits the control packet to the MUX 116. The MUX 116 transmits the control packet to the wireless system 118, and the control packet is transmitted to the slave unit 200 by wireless communication.

On the other hand, in the case streaming is performed at the media player 110, the transmission channel selection output unit 106 transmits the volume control information to the header information addition unit 112. The header information addition unit 112 inserts the volume control information into a part of a streaming data packet, such as header information or the like. The stream packet transmission unit 114 transmits the streaming data packet including the volume control information to the MUX 116. The MUX 116 transmits the streaming data packet including the volume control information to the wireless system 118, and the streaming data packet including the volume control information is transmitted to the slave unit 200 by wireless communication.

Next, processing performed by the slave unit 200 will be described. In the case a control packet including volume control information is transmitted from the master unit 100, this packet is received by the wireless system 202 of the slave unit 200 and is transmitted from the DEMUX 204 to the control packet reception unit 206. The control packet reception unit 206 transmits the received control packet to the volume control information acquisition unit 208. The volume control information acquisition unit 208 acquires the volume control information from the control packet. The volume control information is transmitted to the audio amplifier 216, and the volume of audio is adjusted according to the volume control information.

Also, in the case a streaming data packet including volume control information is transmitted from the master unit 100, this streaming data packet is received by the wireless system 202 of the slave unit 200 and is transmitted from the DEMUX 204 to the stream packet reception unit 210. The stream packet reception unit 210 transmits the received streaming data packet to the header information separation unit 212. The header information separation unit 212 separates the information in the header of the streaming data packet, and transmits the same to the volume control information acquisition unit 208. The volume control information acquisition unit 208 acquires the volume control information from the information in the header. The volume control information is transmitted to the audio amplifier 216, and the volume of audio is adjusted according to the volume control information. After the information in the header is separated at the header information separation unit 212, the streaming data packet is transmitted to the data buffer 214. The data buffer 214 transmits the streaming data packet to the audio amplifier 216. Then, the audio whose volume is adjusted by the audio amplifier 216 is output to the outside from the speaker 218.

As described above, with the system of the present embodiment, the transmission channel selection output unit 106 of the master unit 100 selects only one channel through which volume control information is to be sent, and thus the slave unit 200 can treat received volume control information as the latest information, regardless of the channel used for transmission.

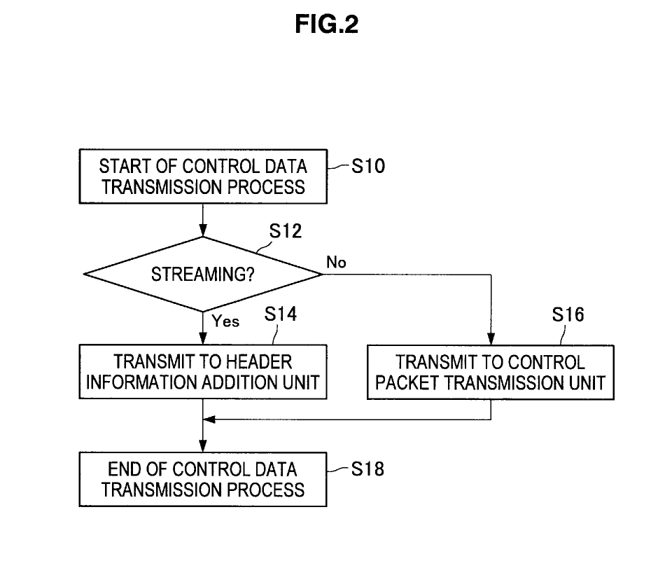

FIG. 2 is a flow chart showing a process of switching a transmission channel of volume control information. First, in step S10, a transmission process of volume control information is started by an operation of a user on the user interface 102. In the next step S12, whether streaming is being performed or not is determined by the media player 110. The result of determination is transmitted to the transmission channel selection output unit 106 as the information regarding streaming mentioned above.

If streaming is being performed, the process proceeds to step S14. In step S14, the transmission channel selection output unit 106 transmits the volume control information to the header information addition unit 112. The volume control information is thereby added to the header of a streaming packet, and is transmitted to the slave unit 200.

Also, if streaming is not being performed, the process proceeds to step S16. In step S16, the volume control information is transmitted to the control packet generation unit 107. An individual control packet including the volume control information is thereby transmitted to the slave unit 200 After steps S14 and S16, the process proceeds to step S18, and the transmission process of control data is ended.

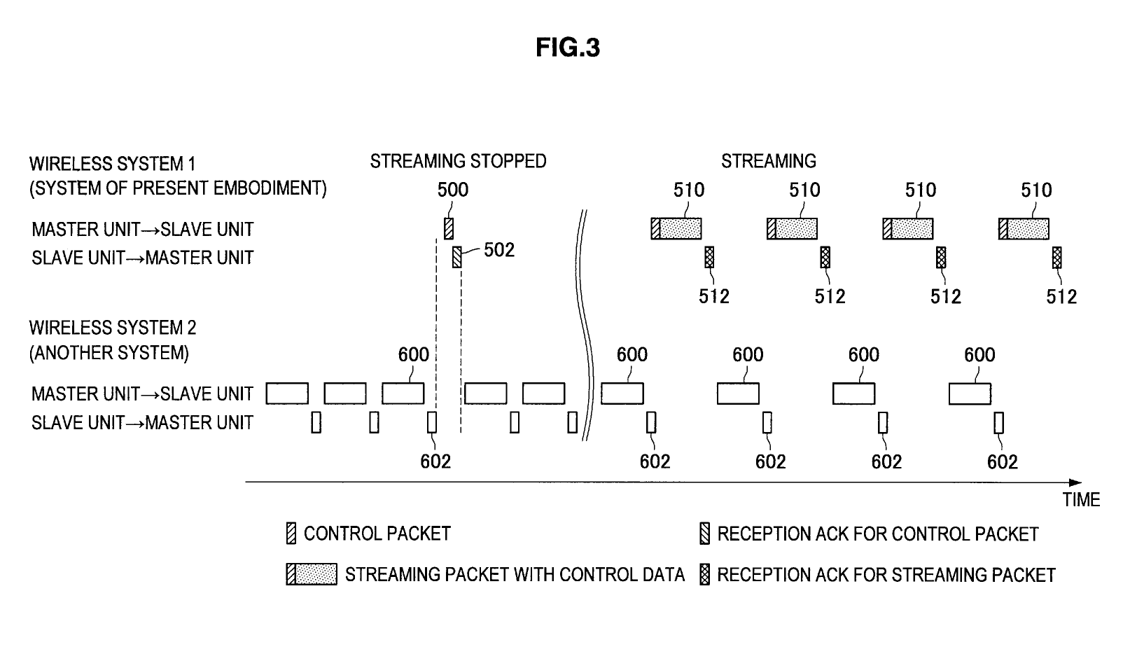

FIG. 3 is a schematic diagram showing a case where packets are transmitted/received between the master unit 100 and the slave unit 200. FIG. 3 shows, for both cases where streaming is stopped and where streaming is performed, transmission/reception of packets in a time-series manner. Also, in FIG. 3, transmission/reception of packets by the master unit 100 and the slave unit 200 of the system of the present embodiment is shown in the upper part, and transmission/reception of packets that is performed in parallel by a master unit and a slave unit of a system different from the system of the present embodiment is shown in the lower part.

First, with the system of the present embodiment, while streaming is stopped, a control packet 500 is transmitted from the master unit 100 to the slave unit 200 according to volume operation by a user. At this time, the control packet 500 is transmitted at the timing when transmission/reception of packets is not performed at the other system. To be more specific, when a data packet 600 is transmitted, in the other system, from the master unit to the slave unit and an ACK 602 for the data packet 600 is transmitted from the slave unit to the master unit, the control packet 500 is then transmitted, in the system of the present embodiment, from the master unit 100 to the slave unit 200. When the control packet 500 is received, the slave unit 200 transmits a reception ACK 502 for the control packet 500 to the master unit 100.

Also, while streaming, a streaming packet 510 to which volume control information has been added is transmitted from the master unit 100 to the slave unit 200 according to volume operation by a user. When the streaming packet 510 is received, the slave unit 200 transmits a reception ACK 512 for the streaming packet 510 to the master unit 100. Also in this case, when the data packet 600 is transmitted, in the other system, from the master unit to the slave unit and the ACK 602 for the data packet 600 is transmitted from the slave unit to the master unit, the streaming packet 510 is then transmitted, in the system of the present embodiment, from the master unit 100 to the slave unit 200.

Accordingly, with the system of the present embodiment, both while streaming and while streaming is stopped, the control packet 500 or the streaming packet 510 including control information can be transmitted from the master unit 100 to the slave unit 200 without a loss of time after transmission of a data packet in another system.

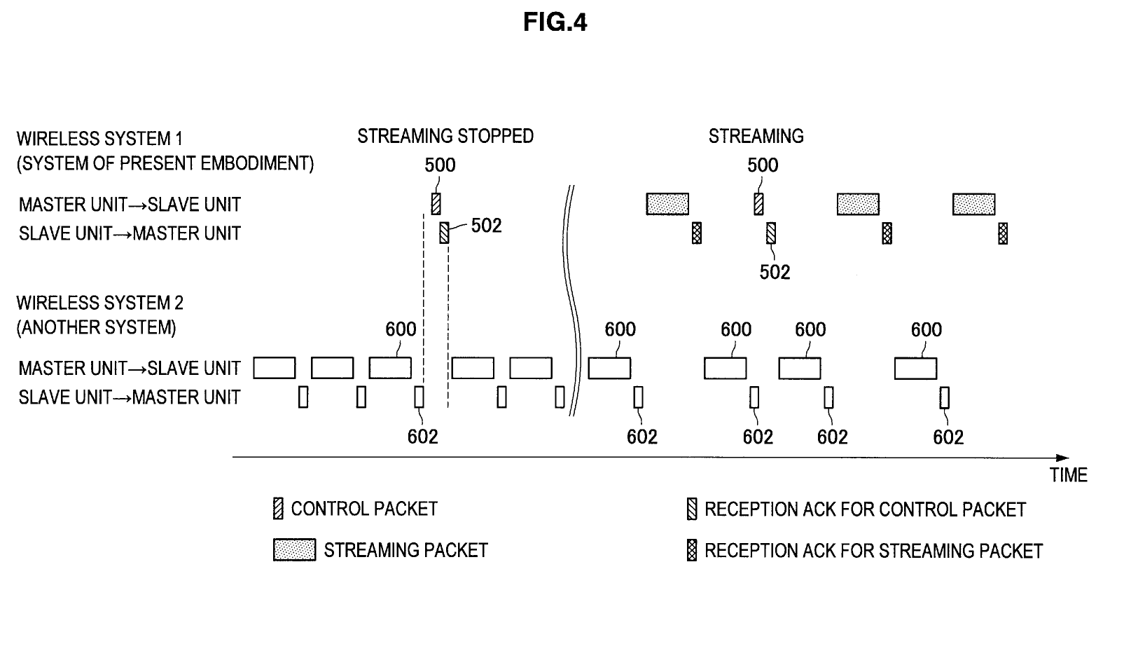

FIG. 4 is a timing chart showing, as a comparative example against the present embodiment, a case of transmitting the volume control information only by a control packet. In the comparative example shown in FIG. 4, the case for while the streaming is stopped is the same as the system of the present embodiment, but in the case the control packet 500 is transmitted while streaming, since the transmission right for data is handed over to another system after the transmission of the control packet 500, a delay occurs in the transmission of the streaming packet. On the other hand, according to the system of the present embodiment shown in FIG. 3, since the volume control information is added to the streaming packet 510, a delay does not occur in the transmission of the streaming packet 510, and the streaming packet 510 can be swiftly transmitted.

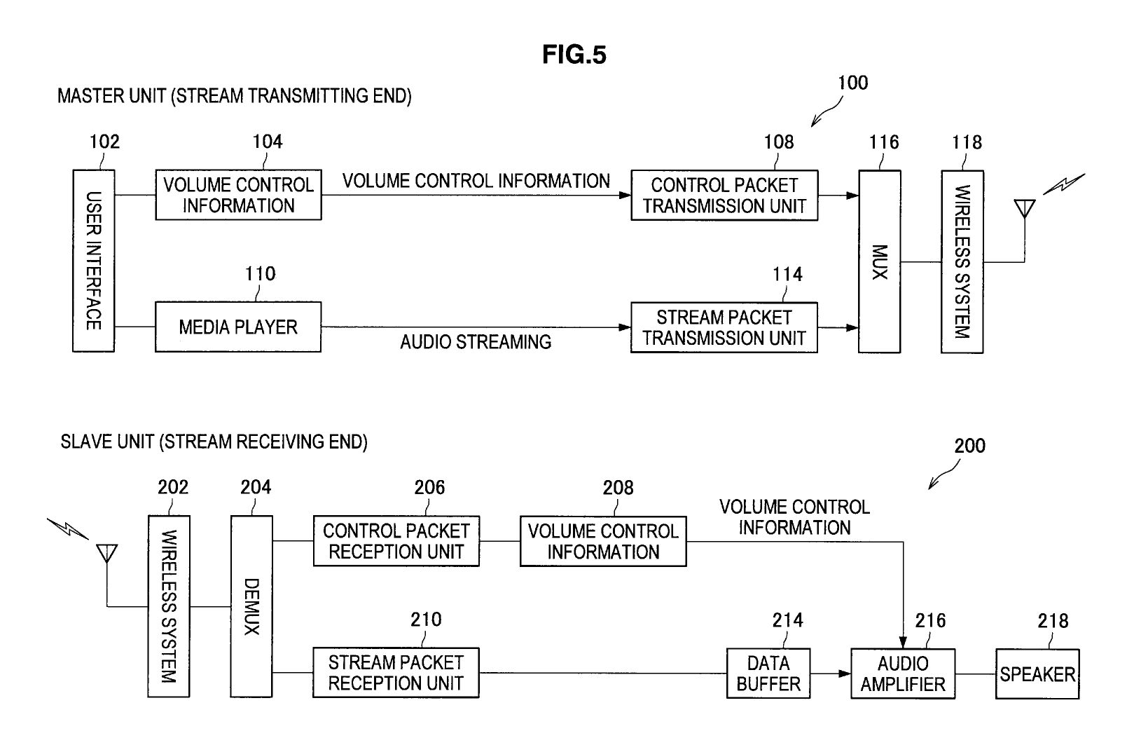

Furthermore, FIG. 5 is a schematic diagram showing configurations of a master unit and a slave unit of a system of the comparative example of FIG. 4. According to the configuration of the master unit shown in FIG. 5, the transmission channel selection output unit 106 and the header information addition unit 112 in FIG. 1 are not provided, and volume control information is transmitted by a control packet at all times. Accordingly, the slave unit is not provided with the header information separation unit 212. Thus, when a control packet including volume control information is generated at the master unit, the control packet 500 is transmitted during transmission of streaming packets, and a delay as described with FIG. 4 is caused.

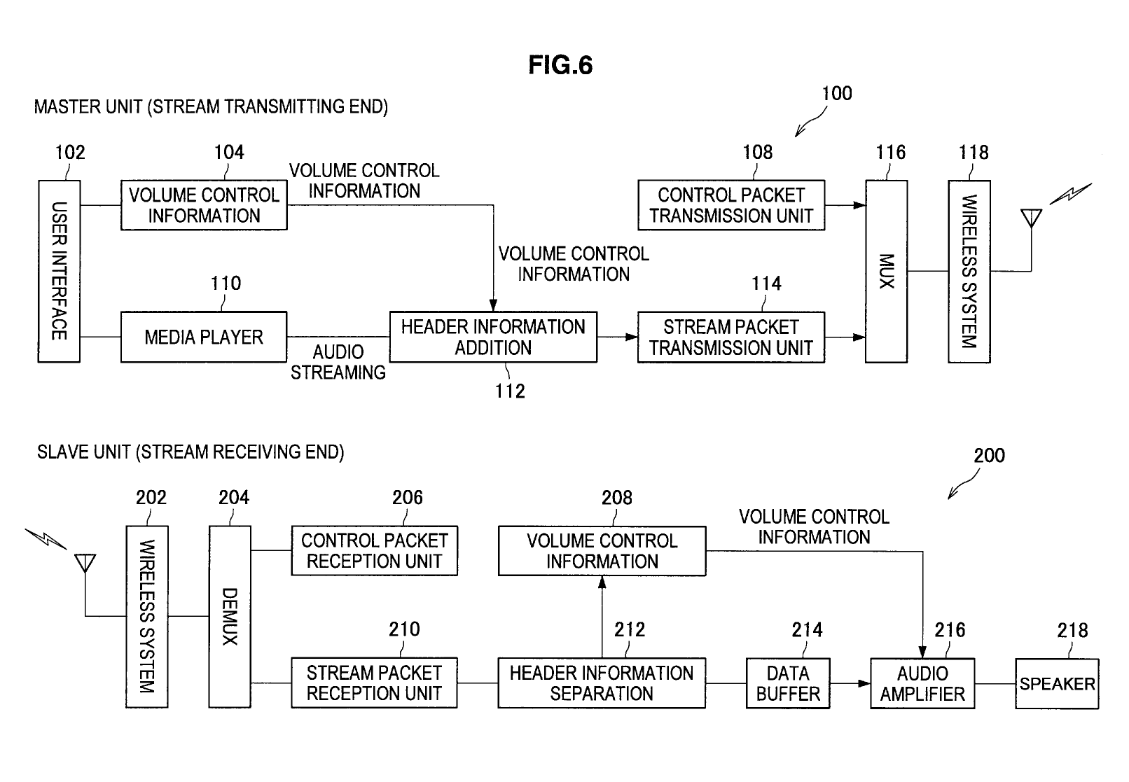

Furthermore, FIG. 6 is a schematic diagram showing, as a comparative example, a configuration where volume control information is transmitted to a slave unit being added at all times to a streaming packet. In the comparative example shown in FIG. 6, since volume control information is added at all times to a streaming packet by the header information addition unit 112, a control packet is not individually transmitted, and changing volume while streaming is stopped becomes difficult.

As described above, according to the example configuration of the present embodiment shown in FIG. 1, the control packet 500 or the streaming packet 510 including control information can be transmitted from the master unit 100 to the slave unit 200 without a loss of time, both while streaming and while streaming is stopped.

Additionally, in the example described above, the volume control information is cited as an example of control information that is transmitted from the master unit 100 to the slave unit 200, but the control information is not limited to such, and the present embodiment can be applied to various types of control information that is transmitted from the master unit 100 to the salve unit 200.

Also, in the example described above, a case has been described where information with a comparatively small amount of data, such as the volume control information, is transmitted as the control packet, but in the case of transmitting information with a larger amount of data as the control information, it can be transmitted by being divided and added to the header of streaming data. Also, in the case the amount of data is large, transmission by one or more individual control packets is possible. For example, when transmitting, from the master unit 100 to the slave unit 200, a cover photograph of audio that is being played back, data is divided into 100 pieces, for example, and data of 20 kBytes to 30 kBytes is transmitted at a time to the slave unit 200. In this case, the title of music is small data compared to the cover photograph, and can be transmitted by an individual control packet. The slave unit 200 is capable of processes such as display of the received cover photograph and the title of music on a display or notification of the same to the user by sound.

Furthermore, in the example described above, the transmission channel selection output unit 106 switches, depending on whether streaming is being performed or not, between whether to transmit control information by an individual control packet or to transmit it by adding it to the header of a streaming packet, but switching may be performed with another factor as the trigger. For example, the transmission channel selection output unit 106 may determine, depending on the duration of transmission at the time of transmission of control information such as volume control information, whether to add the control information to the header of a streaming packet or to transmit it as an individual control packet. For example, in the case the duration of transmission at the time of transmission of control information such as volume control information is longer that a predetermined time, the control information may be transmitted to the slave unit 200, being placed in the header of a streaming packet, and in the case the duration of transmission is the predetermined time or less, the control information may be transmitted as an individual control packet.

As described above, according to the first embodiment, while streaming is stopped, a control packet including volume control information is individually transmitted, and while streaming, a streaming packet including the volume control information is transmitted. The volume control information can be thereby transmitted to a slave unit without delay, both while streaming and while streaming is stopped.

### 2. SECOND EMBODIMENT

### 2.1. Overview of Second Embodiment

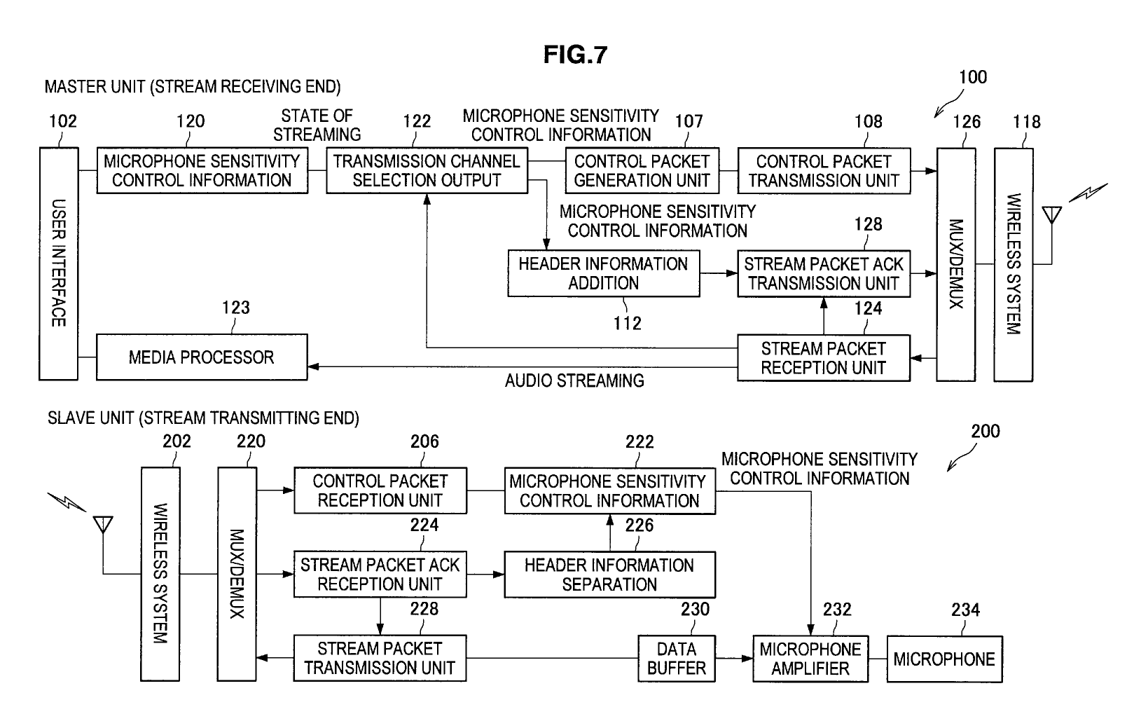

Next, a second embodiment of the present disclosure will be described. FIG. 7 is a schematic diagram showing a configuration of a system according to the second embodiment. In the second embodiment, streaming data is transmitted from a slave unit 200 to a master unit 100. For example, the slave unit 200 is a wireless microphone, and audio data recorded by the microphone is transmitted to the master unit 100 as the streaming data. In this case, the volume of the microphone, that is, the recording sensitivity, is controlled for the slave unit 200 by the master unit 100.

Therefore, in the second embodiment, control data that is transmitted, while streaming, from the master unit 100 to the slave unit 200 is transmitted to the slave unit 200 by being added not to a streaming packet but to a reception ACK response for a streaming packet. Details will be given below.

### 2.2. Configuration of Second Embodiment

FIG. 7 is a schematic diagram showing a configuration of a system according to the second embodiment. As shown in FIG. 7, the master unit 100 includes a user interface 102, a microphone sensitivity control information acquisition unit 120, a transmission channel selection output unit 122, a control packet generation unit 107, a control packet transmission unit 108, a media processor 123, a header information addition unit 112, a stream packet reception unit 124, a MUX/DEMUX 126, a stream packet ACK transmission unit 128 and a wireless system 118.

Also, the slave unit 200 includes a wireless system 202, a MUX/DEMUX 220, a control packet reception unit 206, a microphone sensitivity control information acquisition unit 222, a stream packet ACK reception unit 224, a header information separation unit 226, a stream packet transmission unit 228, a data buffer 230, a microphone amplifier 232 and a microphone 234.

In the configuration shown in FIG. 7, the microphone 234 of the slave unit 200 acquires external sound. The microphone amplifier 232 amplifies the audio signal that the microphone 234 has acquired. Data of amplified audio signal is accumulated in the data buffer 230, and is transmitted, as a streaming packet, from the stream packet transmission unit 228 to the MUX/DEMUX 220, and from the wireless system 202 to the master unit 100.

At the master unit 100, when the streaming packet transmitted from the slave unit 200 is received by the wireless system 118, the streaming packet is transmitted from the MUX/DEMUX 126 to the stream packet reception unit 124, and is received by the stream packet reception unit 124. A playback process, a recording process or the like is performed on the streaming packet at the media processor 123.

Furthermore, the stream packet reception unit 124 transmits information regarding the state of streaming (information indicating whether streaming is performed or not) to the transmission channel selection output unit 122.

At the master unit 100, operation of microphone sensitivity by a user is input to the user interface 102 and is acquired by the microphone sensitivity control information acquisition unit 120 as microphone sensitivity control information. The microphone sensitivity control information is transmitted to the transmission channel selection output unit 122. In the case the stream packet reception unit 124 is not receiving a streaming packet, the transmission channel selection output unit 122 transmits the microphone sensitivity control information to the control packet generation unit 107. The control packet generation unit 107 generates a control packet including the microphone sensitivity control information, and transmits the same to the control packet transmission unit 108. The control packet transmission unit 108 transmits the control packet to the MUX/DEMUX 126. The MUX/DEMUX 126 transmits the control packet to the wireless system 118, and the control packet is transmitted to the slave unit 200 by wireless communication.

On the other hand, in the case the stream packet reception unit 124 is receiving streaming packets, an ACK for a streaming data packet is transmitted from the master unit 100 to the slave unit 200 at every packet reception. In this case, the transmission channel selection output unit 122 transmits the microphone sensitivity control information to the header information addition unit 112. The header information addition unit 112 inserts the microphone sensitivity control information into a part of the ACK (for example, header information or the like) for the streaming data packet. The stream packet ACK transmission unit 128 transmits the ACK, for the streaming data packet, including the microphone sensitivity control information to the MUX/DEMUX 126. The MUX/DEMUX 126 transmits the ACK, for the streaming data packet, including the microphone sensitivity control information to the wireless system 118, and the ACK, for the streaming data packet, including the microphone sensitivity control information is transmitted to the slave unit 200 by wireless communication.

As described above, in the second embodiment, streaming is monitored by the slave unit 200, and switching is performed between whether to generate a control packet including microphone sensitivity control information or to generate an ACK including the microphone sensitivity control information, based on whether streaming is performed or not. Also, if a streaming packet from the slave unit 200 is not received within a predetermined period of time after microphone sensitivity control information transmitted from the microphone sensitivity control information acquisition unit 120 arrived at the transmission channel selection output unit 122, a control packet including the microphone sensitivity control information is generated by the control packet generation unit 107, and the control packet is transmitted as an individual packet.

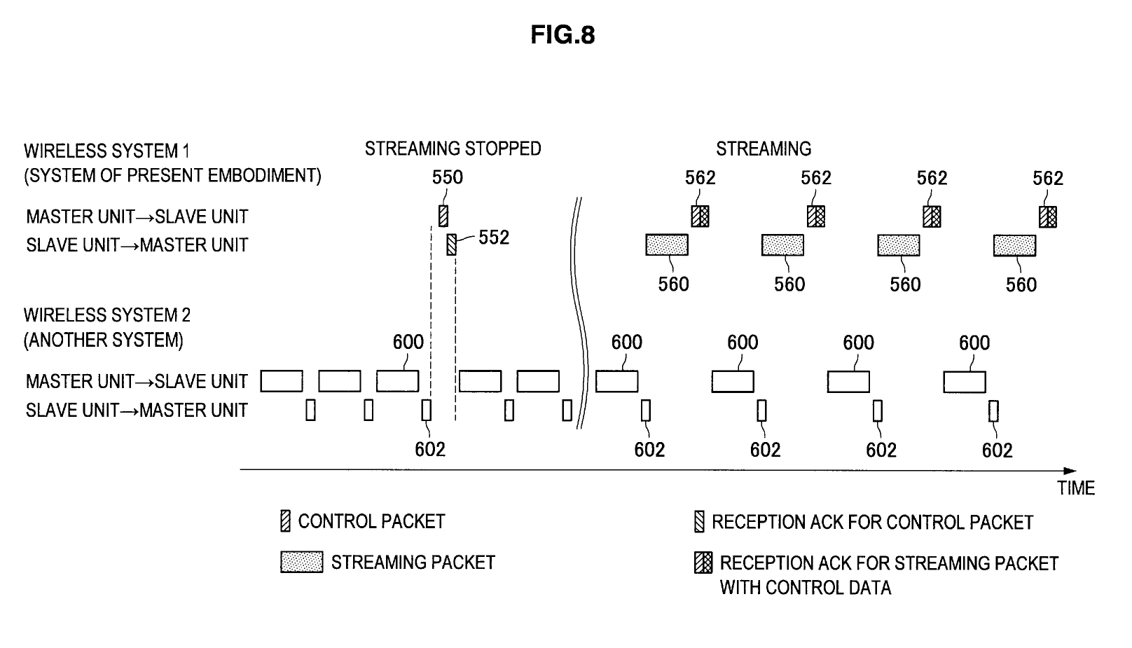

FIG. 8 is a schematic diagram showing a case, of the second embodiment, where packets are transmitted/received between the master unit 100 and the slave unit 200. FIG. 8 shows, for both cases where streaming is stopped and where streaming is performed, transmission/reception of packets in a time-series manner.

First, when a user operates the master unit 100 and adjusts the sensitivity of a microphone while streaming is stopped, a control packet 550 is transmitted from the master unit 100 to the slave unit 200 according to this operation. At this time, the control packet 550 is transmitted at the timing when transmission/reception of packets is not performed at another system. To be more specific, when a data packet 600 is transmitted, in the other system, from a master unit to a slave unit and an ACK 602 for the data packet 600 is transmitted from the slave unit to the master unit, the control packet 550 is then transmitted, in the system of the present embodiment, from the master unit 100 to the slave unit 200. When the control packet 550 is received, the slave unit 200 transmits a reception ACK 552 for the control packet 550 to the master unit 100.

Also, while streaming, a streaming packet 560 is transmitted from the slave unit 200 to the master unit 100. When the streaming packet 560 is received, the master unit 100 transmits a reception ACK 562 for the streaming packet 560 to the slave unit 200. When the user adjusts the sensitivity of the microphone, a reception ACK 562 to which sensitivity information of the microphone has been added is transmitted from the master unit 100 to the slave unit 200. Also in this case, when the data packet 600 is transmitted, in the other system, from the master unit to the slave unit and the ACK 602 for the data packet 600 is transmitted from the slave unit to the master unit, the streaming packet 560 is then transmitted, in the system of the present embodiment, from the slave unit 200 to the master unit 100.

Accordingly, with the system of the present embodiment, both while streaming and while streaming is stopped, the control packet 550 or the reception ACK 562 to which sensitivity information of a microphone has been added can be transmitted from the master unit 100 to the slave unit 200 without a loss of time after completion of transmission in another system.

Additionally, in the case control data or status information of the slave unit 200 has to be transmitted from the slave unit 200 to the master unit 100, switching is allowed, as in the first embodiment, between a case where these pieces of information are transmitted as individual control packets and a case where they are transmitted being added to streaming data packets.

Additionally, also in the second embodiment, sensitivity information of a microphone is cited as an example of the control information that is transmitted from the master unit 100 to the slave unit 200, but application to various types of control information transmitted from the master unit 100 to the slave unit 200 is possible, without being limited to that mentioned above.

As described above, according to the second embodiment, while streaming is stopped, a control packet including sensitivity information of a microphone is individually transmitted, and while streaming, a reception ACK including the sensitivity information of the microphone is transmitted. The sensitivity information of the microphone can be thereby transmitted to the slave unit 200 without delay, both while streaming and while streaming is stopped.

### 3. THIRD EMBODIMENT

### 3.1. Overview of Third Embodiment

Next, a third embodiment of the present disclosure will be described. The third embodiment shows a case where control data or status information is transmitted from a slave unit 200 to a master unit 100 in a system same as that of the first embodiment. While streaming from the master unit 100 to the slave unit 200 is performed, control data is transmitted to the master unit 100, being added to a reception ACK response for a streaming packet.

### 3.2. Configuration of Third Embodiment

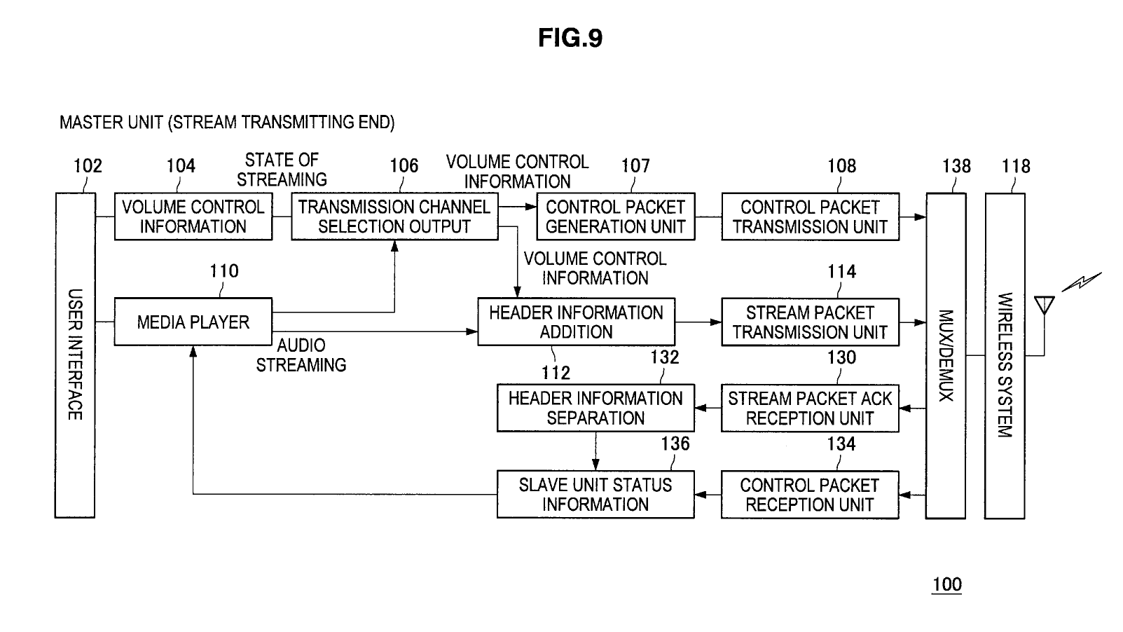

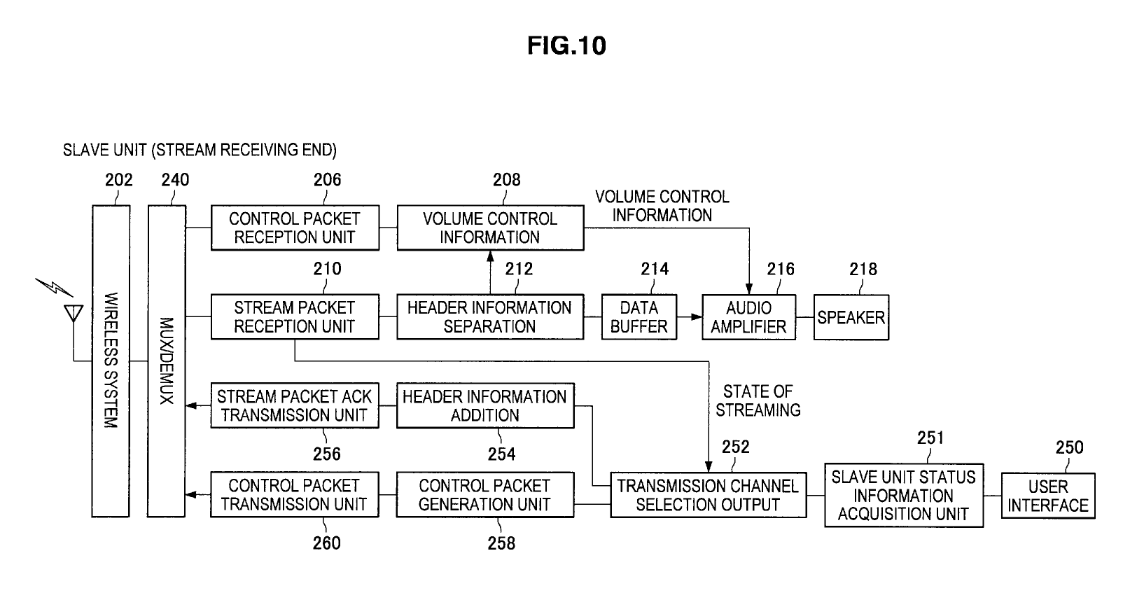

FIGS. 9 and 10 are schematic diagrams showing configurations of a system according to the third embodiment. Here, FIG. 9 shows the master unit 100, and FIG. 10 shows the slave unit 200. As shown in FIG. 9, the master unit 100 includes a user interface 102, a volume control information acquisition unit 104, a transmission channel selection output unit 106, a control packet generation unit 107, a control packet transmission unit 108, a media player 110, a header information addition unit 112, a stream packet transmission unit 114, a stream packet ACK reception unit 130, a header information separation unit 132, a control packet reception unit 134, a slave unit status information acquisition unit 136, a MUX/DEMUX 138 and a wireless system 118.

Also, as shown in FIG. 10, the slave unit 200 includes a wireless system 202, a MUX/DEMUX 240, a control packet reception unit 206, a volume control information acquisition unit 208, a stream packet reception unit 210, a header information separation unit 212, a data buffer 214, an audio amplifier 216, a speaker 218, a user interface 250, a slave unit status information acquisition unit 251, a transmission channel selection output unit 252, a header information addition unit 254, a stream packet ACK transmission unit 256, a control packet generation unit 258 and a control packet transmission unit 260.

In the case of transmitting volume control information from the master unit 100, processing same as that of the first embodiment is performed both while streaming and while streaming is stopped.

Also, in the case of transmitting control information such as status information from the slave unit 200 to the master unit 100, information indicating whether streaming is performed or not is transmitted from the stream packet reception unit 210 to the transmission channel selection output unit 252. In the case streaming is performed, the transmission channel selection output unit 252 transmits control information which has been input from the user interface 250 and acquired by the slave unit status information acquisition unit 251 to the header information addition unit 254. The header information addition unit 254 adds the control information to a reception ACK for a streaming packet. The stream packet ACK transmission unit 256 transmits the reception ACK to which the control information has been added. The reception ACK is transmitted to the MUX/DEMUX 240, and is transmitted from the wireless system 202 to the master unit 100.

Furthermore, while streaming is stopped, the transmission channel selection output unit 252 transmits the control information which has been input from the user interface 250 and acquired by the slave unit status information acquisition unit 251 to the control packet generation unit 258. The control packet generation unit 258 generates a control packet including the control information. The control packet transmission unit 260 performs a process of transmitting the control packet. The control packet is transmitted to the MUX/DEMUX 240, and is transmitted from the wireless system 202 to the master unit 100.

As described above, according to the third embodiment, while streaming is stopped, a control packet including control information such as status information of the slave unit 200 is individually transmitted, and while streaming, a reception ACK including the control information is transmitted. The control information such as the status of the slave unit 200 can be thereby transmitted to the master unit 100 without delay, both while streaming and while streaming is stopped.

### 4. FOURTH EMBODIMENT

### 4.1. Overview of Fourth Embodiment

Next, a fourth embodiment of the present disclosure will be described. In the fourth embodiment, a case is shown where transmission of a plurality of audio channels is performed. This corresponds, for example, to a case where, in a home theater system or the like, audio streaming is performed by wireless transmission to each of front and rear speakers. In this case, the state of streaming to each of the speakers changes depending on the type of audio to be played back and the playback mode. That is, in the case of playback of music, such as a CD, audio is normally transmitted only to front L/R speakers, but in the case of playback of movie content, such as a DVD or BD, audio transmission is performed also to rear speakers.

With such multi-channel audio, the state of streaming changes for each audio channel. Thus, in the fourth embodiment, the state of streaming of a corresponding audio channel is referred to for each destination of control data. As a result, even in the case of transmitting the same volume control information, the volume control information is transmitted, while streaming is stopped, as an individual control packet to a slave unit to which a certain audio channel is to be transmitted. Also, while streaming, the volume control information is transmitted, being embedded in a streaming data packet, to a slave unit to which another audio channel is to be transmitted.

### 4.2. Configuration of Fourth Embodiment

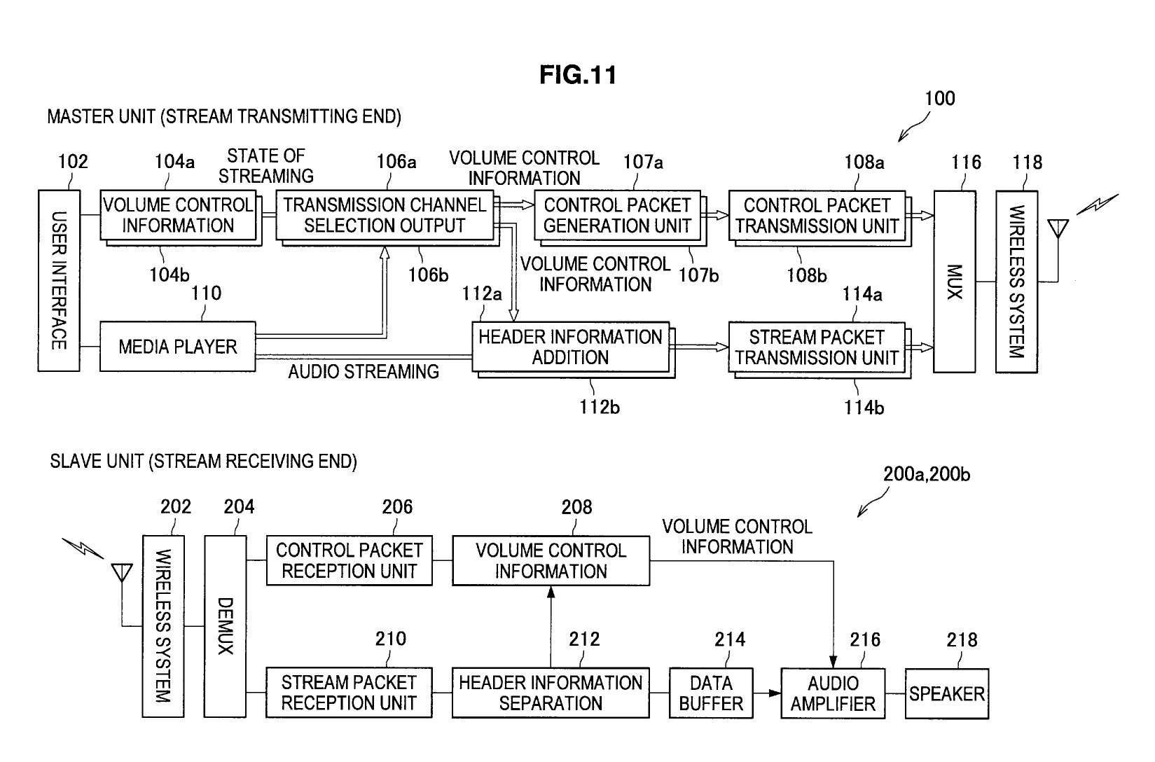

FIG. 11 is a schematic diagram showing a configuration of a system according to the fourth embodiment. The basic configuration of the master unit 100 shown in FIG. 11 is the same as that of the first embodiment shown in FIG. 1. However, the volume control information acquisition unit 104, the transmission channel selection output unit 106, the control packet generation unit 107, the control packet transmission unit 108, the header information addition unit 112 and the stream packet transmission unit 114 in FIG. 1 are provided for each channel. In the example shown in FIG. 11, streaming is performed from the master unit 100 to two slave units 200a and 200b. For example, the slave unit 200a corresponds to a front speaker, and the slave unit 200b corresponds to a rear speaker. Accordingly, to conform to the two slave units 200a and 200b, the master unit 100 includes volume control information acquisition units 104a and 104b, transmission channel selection output units 106a and 106b, control packet generation units 107a and 107b, control packet transmission units 108a and 108b, header information addition units 112a and 112b, and stream packet transmission units 114a and 114b. The configuration of the slave units 200a and 200b is the same as that of the first embodiment.

In the configuration shown in FIG. 11, the volume control information acquisition unit 104a, the transmission channel selection output unit 106a, the control packet generation unit 107a, the control packet transmission unit 108a, the header information addition unit 112a and the stream packet transmission unit 114a function to transmit volume control information to the slave unit 200a. Also, the volume control information acquisition unit 104b, the transmission channel selection output unit 106b, the control packet generation unit 107b, the control packet transmission unit 108b, the header information addition unit 112b and the stream packet transmission unit 114b function to transmit the volume control information to the slave unit 200b. According to this configuration, the volume control information can be transmitted individually to the slave unit 200a and the slave unit 200b by, for example, transmitting the volume control information to the slave unit 200a by a control packet while streaming to the slave unit 200a, and by, for example, adding the volume control information to the header of a streaming packet and transmitting the same to the slave unit 200b while streaming to the slave unit 200b is stopped.

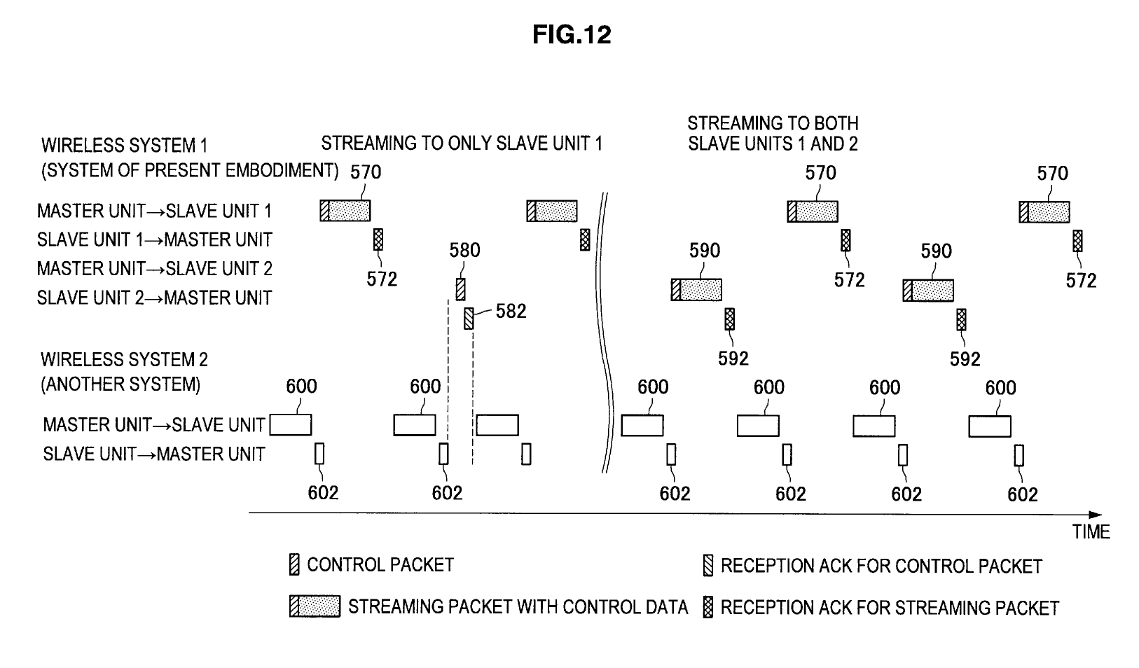

FIG. 12 is a schematic diagram showing a case where packets are transmitted/received between the master unit 100 and the slave units 200a and 200b. FIG. 12 shows, for both cases where streaming is stopped and where streaming is performed, transmission/reception of packets in a time-series manner. Also, in FIG. 12, transmission/reception of packets by the master unit 100 and the slave units 200a and 200b of a system 400 of the present embodiment is shown in the upper part, and transmission/reception of packets that is performed in parallel by a master unit and a slave unit of a system different from the system 400 of the present embodiment is shown in the lower part. Furthermore, in FIG. 12, the slave unit 200a is shown as a slave unit 1, and the slave unit 200b is shown as a slave unit 2.

First, in the case of streaming only to the slave unit 200a, a streaming packet 570 to which volume control information has been added is transmitted to the slave unit 200a according to volume operation by a user. Since streaming is not performed to the slave unit 200b, a control packet 580 including the volume control information is transmitted from the master unit 100 to the slave unit 200b. When the streaming packet 570 is received, the slave unit 200a transmits an ACK 572 for the streaming packet 570 to the master unit 100. Also, when the control packet 580 is received, the slave unit 200b transmits an ACK 582 for the control packet 580 to the master unit 100. At this time, the streaming packet 570 to which the volume control information has been added, the control packet 580 including the volume control information, and the ACKs 572 and 582 are transmitted at the timing when transmission/reception of packets 600 and ACKs 602 is not performed at the other system.

Furthermore, in the case of streaming to both the slave units 200a and 200b, streaming packets 570 and 590 to which the volume control information has been added are transmitted to the slave units 200a and 200b according to volume operation by the user. At this time, streaming packets to which the volume control information has been added are transmitted at timing when transmission/reception of packets 600 and ACKs 602 is not performed at the other system.

Furthermore, in the case streaming is not performed to either of the slave units 200a and 200b, control packets including the volume control information are transmitted from the master unit 100 to the slave units 200a and 200b according to volume operation by the user. Also in this case, the control packets including the volume control information are transmitted at the timing when transmission/reception of packets is not performed at the other system.

Also in the fourth embodiment, the transmission channel selection output units 106a and 106b may switch, with other than information indicating whether streaming is performed or not as a trigger, between whether control information is to be added to a streaming packet and whether the control information is to be transmitted as an individual control packet. For example, in the case the number of targets of transmission (the slave units 200) of control information or the like is more than a predetermined number, the transmission channel selection output units 106a and 106b may transmit the control information to each slave unit 200 by placing it in the headers of streaming data packets, and in the case the number of targets of transmission (the slave units 200) is the predetermined number or less, the control information may be transmitted as individual control packets.

As described above, according to the fourth embodiment, also in the case of transmitting the volume control information to a plurality of slave units 200a and 200b, control packets including the volume control information are individually transmitted while streaming is stopped, and streaming packets including the volume control information are transmitted while streaming. The volume control information can be thereby transmitted to the slave units without delay, both while streaming and while streaming is stopped.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A communication device including:

a streaming packet transmission unit for transmitting a streaming packet;

a control information acquisition unit for acquiring control information regarding the streaming packet;

a control packet transmission unit for transmitting a control packet including the control information;

a control information addition unit for adding the control information to the streaming packet; and

a transmission channel selection unit for selecting, according to a predetermined condition, whether to transmit the control packet including the control information or to transmit the streaming packet to which the control information has been added.

(2) The communication device according to (1), including:

a streaming packet output unit for outputting the streaming packet,

wherein the transmission channel selection unit causes, in a case the streaming packet output unit outputs the streaming packet, the streaming packet to which the control information has been added to be transmitted, and causes, in a case the streaming packet output unit does not output the streaming packet, the control packet including the control information to be transmitted.

(3) The communication device according to (1), wherein the transmission channel selection unit causes, in a case duration of transmission of the control information is less than a predetermined period of time, the streaming packet to which the control information has been added to be transmitted, and causes, in a case the duration of transmission of the control information is equal to or longer than the predetermined period of time, the control packet including the control information to be transmitted.

(4) The communication device according to (1), wherein the streaming packet transmission unit and the control packet transmission unit transmit the streaming packet and the control information regarding the streaming packet to each of a plurality of devices.

(5) The communication device according to (4), wherein the transmission channel selection unit causes, in a case there are more than a predetermined number of devices to which the control information packet and the streaming packet are to be transmitted, the streaming packet to which the control information has been added to be transmitted, and causes, in a case there are a predetermined number or less of the devices to which the control information packet and the streaming packet are to be transmitted, the control packet including the control information to be transmitted.

(6) A communication device including:

a streaming packet reception unit for receiving a streaming packet and control information, regarding the streaming packet, added to the streaming packet;

a control packet reception unit for receiving a control packet including the control information regarding the streaming packet;

a control information acquisition unit for acquiring the control information from the streaming packet or the control packet; and

a control unit for controlling information of the streaming packet based on the control information.

(7) The communication device according to (6), wherein the control information acquisition unit acquires, in a case the streaming packet reception unit receives the streaming packet, the control information from the streaming packet, and acquires, in a case the streaming packet reception unit does not receive the streaming packet, the control information from the control packet.

(8) A communication device including:

a streaming packet reception unit for receiving a streaming packet;

a reception acknowledgement information transmission unit for transmitting a reception acknowledgement information (ACK) when the streaming packet is received;

a control information acquisition unit for acquiring control information regarding the streaming packet;

a control packet transmission unit for transmitting a control packet including the control information;

a control information addition unit for adding the control information to the reception acknowledgement information (ACK); and

a transmission channel selection unit for selecting, according to a predetermined condition, whether to transmit the control packet including the control information or to transmit the reception acknowledgement information (ACK) to which the control information has been added.

(9) The communication device according to (8), wherein the transmission channel selection unit causes, in a case the streaming packet reception unit receives the streaming packet, the reception acknowledgement information to which the control information has been added to be transmitted, and causes, in a case the streaming packet reception unit does not receive the streaming packet, the control packet including the control information to be transmitted.

(10) A communication device including:

a streaming packet transmission unit for transmitting a streaming packet;

a control packet reception unit for receiving a control packet including control information regarding the streaming packet;

a reception acknowledgement information (ACK) reception unit for receiving reception acknowledgement information (ACK) for the streaming packet and the control information, regarding the streaming packet, added to the reception acknowledgement information (ACK);

a control information acquisition unit for acquiring the control information from the reception acknowledgement information (ACK) or the control packet; and

a control unit for controlling information of the streaming packet based on the control information.

(11) A communication system including:

a first communication device including
a streaming packet transmission unit for transmitting a streaming packet,
a control information acquisition unit for acquiring control information regarding the streaming packet,
a control packet transmission unit for transmitting a control packet including the control information,
a control information addition unit for adding the streaming packet to the control information, and
a transmission channel selection unit for selecting, according to a predetermined condition, whether to transmit the control packet including the control information or to transmit the streaming packet to which the control information has been added; and

a second communication device including
a streaming packet reception unit for receiving the streaming packet,
a control packet reception unit for receiving the control packet,
a control information acquisition unit for acquiring the control information from the streaming packet or the control packet, and
a control unit for controlling information of the streaming packet based on the control information.

(12) A communication system including:

a first communication device including
a streaming packet reception unit for receiving a streaming packet,
a reception acknowledgement information transmission unit for transmitting reception acknowledgement information (ACK) when the streaming packet is received,
a control information acquisition unit for acquiring control information regarding the streaming packet,
a control packet transmission unit for transmitting a control packet including the control information,
a control information addition unit for adding the control information to the reception acknowledgement information (ACK), and
a transmission channel selection unit for selecting, according to a predetermined condition, whether to transmit the control packet including the control information or to transmit the reception acknowledgement information (ACK) to which the control information has been added; and

a second communication device including
a streaming packet transmission unit for transmitting the streaming packet,
a control packet reception unit for receiving the control packet,
a reception acknowledgement information (ACK) reception unit for receiving the reception acknowledgement information (ACK) for the streaming packet and the control information, regarding the streaming packet, added to the reception acknowledgement information (ACK),
a control information acquisition unit for acquiring the control information from the reception acknowledgement information (ACK) or the control packet, and
a control unit for controlling information of the streaming packet based on the control information.

The present disclosure contains subject matter related to that disclosed in Japanese Priority Patent Application JP 2011-075767 filed in the Japan Patent Office on Mar. 30, 2011, the entire content of which is hereby incorporated by reference.

What is claimed is:

1. A communication device comprising:
a streaming packet transmission unit for transmitting a streaming packet;
a control information acquisition unit for acquiring control information regarding the streaming packet;
a control packet transmission unit for transmitting a control packet including the control information;
a control information addition unit for adding the control information to the streaming packet; and
a transmission channel selection unit for selecting, according to a predetermined condition, whether to transmit the control packet including the control information or to transmit the streaming packet to which the control information has been added.

2. The communication device according to claim 1, comprising:
a streaming packet output unit for outputting the streaming packet,
wherein the transmission channel selection unit causes, in a case the streaming packet output unit outputs the streaming packet, the streaming packet to which the control information has been added to be transmitted, and causes, in a case the streaming packet output unit does not output the streaming packet, the control packet including the control information to be transmitted.

3. The communication device according to claim 1, wherein the transmission channel selection unit causes, in a case duration of transmission of the control information is less than a predetermined period of time, the streaming packet to which the control information has been added to be transmitted, and causes, in a case the duration of transmission of the control information is equal to or longer than the predetermined period of time, the control packet including the control information to be transmitted.

4. The communication device according to claim 1, wherein the streaming packet transmission unit and the control packet transmission unit transmit the streaming packet and the control information regarding the streaming packet to each of a plurality of devices.

5. The communication device according to claim 4, wherein the transmission channel selection unit causes, in a case there are more than a predetermined number of devices to which the control information packet and the streaming packet are to be transmitted, the streaming packet to which the control information has been added to be transmitted, and causes, in a case there are a predetermined number or less of the devices to which the control information packet and the streaming packet are to be transmitted, the control packet including the control information to be transmitted.

6. A communication device comprising:
a streaming packet reception unit for receiving a streaming packet and control information, regarding the streaming packet, added to the streaming packet;
a control packet reception unit for receiving a control packet including the control information regarding the streaming packet;
a control information acquisition unit for acquiring the control information from the streaming packet or the control packet; and
a control unit for controlling information of the streaming packet based on the control information.

7. The communication device according to claim 6, wherein the control information acquisition unit acquires, in a case the streaming packet reception unit receives the streaming packet, the control information from the streaming packet, and acquires, in a case the streaming packet reception unit does not receive the streaming packet, the control information from the control packet.

8. A communication device comprising:
a streaming packet reception unit for receiving a streaming packet;
a reception acknowledgement information transmission unit for transmitting a reception acknowledgement information when the streaming packet is received;
a control information acquisition unit for acquiring control information regarding the streaming packet;
a control packet transmission unit for transmitting a control packet including the control information;
a control information addition unit for adding the control information to the reception acknowledgement information; and
a transmission channel selection unit for selecting, according to a predetermined condition, whether to transmit the control packet including the control information or to transmit the reception acknowledgement information to which the control information has been added.

9. The communication device according to claim 8, wherein the transmission channel selection unit causes, in a case the streaming packet reception unit receives the streaming packet, the reception acknowledgement information to which the control information has been added to be transmitted, and causes, in a case the streaming packet reception unit does not receive the streaming packet, the control packet including the control information to be transmitted.

10. A communication device comprising:
a streaming packet transmission unit for transmitting a streaming packet;
a control packet reception unit for receiving a control packet including control information regarding the streaming packet;
a reception acknowledgement information reception unit for receiving reception acknowledgement information for the streaming packet and the control information, regarding the streaming packet, added to the reception acknowledgement information;
a control information acquisition unit for acquiring the control information from the reception acknowledgement information or the control packet; and
a control unit for controlling information of the streaming packet based on the control information.

11. A communication system comprising:
a first communication device including
a streaming packet transmission unit for transmitting a streaming packet,
a control information acquisition unit for acquiring control information regarding the streaming packet,
a control packet transmission unit for transmitting a control packet including the control information,
a control information addition unit for adding the streaming packet to the control information, and
a transmission channel selection unit for selecting, according to a predetermined condition, whether to transmit the control packet including the control information or to transmit the streaming packet to which the control information has been added; and
a second communication device including
a streaming packet reception unit for receiving the streaming packet,
a control packet reception unit for receiving the control packet,
a control information acquisition unit for acquiring the control information from the streaming packet or the control packet, and
a control unit for controlling information of the streaming packet based on the control information.

12. A communication system comprising:
a first communication device including
a streaming packet reception unit for receiving a streaming packet,
a reception acknowledgement information transmission unit for transmitting reception acknowledgement information when the streaming packet is received,
a control information acquisition unit for acquiring control information regarding the streaming packet,
a control packet transmission unit for transmitting a control packet including the control information,
a control information addition unit for adding the control information to the reception acknowledgement information, and
a transmission channel selection unit for selecting, according to a predetermined condition, whether to transmit the control packet including the control information or to transmit the reception acknowledgement information to which the control information has been added; and
a second communication device including
a streaming packet transmission unit for transmitting the streaming packet,
a control packet reception unit for receiving the control packet,
a reception acknowledgement information reception unit for receiving the reception acknowledgement information for the streaming packet and the control information, regarding the streaming packet, added to the reception acknowledgement information,
a control information acquisition unit for acquiring the control information from the reception acknowledgement information or the control packet, and
a control unit for controlling information of the streaming packet based on the control information.
